(19) United States
(12) Patent Application Publication
(10) Pub. No.: US 2019/0162227 A1
(43) Pub. Date: May 30, 2019

(54) DRIVELINE ASSEMBLY WITH VARIABLE THICKNESS TUBE WALL

(71) Applicant: Neapco Intellectual Property Holdings, LLC, Farmington Hills, MI (US)

(72) Inventors: Gary K. Parker, Shelby Twp., MI (US); Robert Joseph Wehner, Livonia, MI (US)

(21) Appl. No.: 16/149,361

(22) Filed: Oct. 2, 2018

Related U.S. Application Data
(60) Provisional application No. 62/590,942, filed on Nov. 27, 2017.

(51) Int. Cl. F16C 3/02; F16D 1/10

(52) U.S. Cl. CPC F16C 3/023; F16D 3/16; F16D 2001/103; F16D 1/10

(57) ABSTRACT

A driveline assembly for a vehicle including a tube of a first material extending about and along an axis between a proximal end and a distal end and having an outer surface and an inner surface. A fitting of a second material extends axially between a first end and a second end. The first end of the fitting is coupled with the distal end of the tube. A weld interconnects the first end of the fitting and the distal end of the tube. The tube has a thicker portion at the distal end with a first thickness, and a thinner portion axially adjacent to the thicker portion with a second thickness. The first thickness is greater than the second thickness.

### CROSS-REFERENCE TO RELATED APPLICATIONS

This U.S. patent application claims the benefit of U.S. Provisional Patent Application Ser. No. 62/590,942 filed Nov. 27, 2017, entitled “Driveline Assembly with Variable Thickness Tube Wall,” the entire disclosure of the application being considered part of the disclosure of this application and hereby incorporated by reference.

### TECHNICAL FIELD

A driveline assembly for a vehicle. More particularly, a driveline assembly including a tube of a first material that is welded to an end of a fitting of a second material. The tube has a variable wall thickness to provide a large surface area for the weld while reducing the weight of the driveline assembly.

### BACKGROUND

Driveline assemblies are known in the art for transferring power from a power source to wheels of a vehicle. Driveline assemblies for automobiles typically include a propeller shaft assembly for interconnecting a transmission or transfer case and a differential. Conventionally, the propeller shaft assembly includes a steel tube that is connected to a first universal joint at a first end. A steel spline shaft or other fitting is fixed to a second end of the tube. Efforts have been made to reduce the weight of such propeller shaft assemblies. For example, it is known to make the tube out of light-weight aluminum instead of steel. Under this arrangement the fitting is typically made of steel, and thus a bi-metallic welding method is used to connect the tube and the fitting. A disadvantage of this approach is that a cyclic torsional fatigue life or torsional strength of the bi-metallic weld has been shown to be significantly lower than that of equivalently sized uni-metallic welds. To improve cyclic torsional fatigue life or torsional strength, it is known to utilize tubes having a large wall thickness to increase the surface area of the weld, however, the increased thickness adds significant weight to the assembly and thus defeats the original intent of providing reduced weight. Accordingly, there remains a need for improvements to driveline assemblies.

### SUMMARY

This section provides a general summary and is not intended to be an exhaustive and comprehensive listing of all possible aspects, features and objectives associated with the present disclosure.

According to an aspect of the disclosure, a driveline assembly for a vehicle is provided. The driveline assembly includes a tube of a first material extending about and along an axis between a proximal end and a distal end and having an outer surface and an inner surface. A fitting of a second material extends axially between a first end and a second end. The first end is coupled with the distal end of the tube. A weld interconnects the first end of the fitting and the distal end of the tube. The tube has a thicker portion at the distal end with a first thickness between the outer surface and the inner surface, and a thinner portion axially adjacent to the thicker portion with a second thickness between the outer surface and the inner surface. The first thickness is greater than the second thickness to reduce weight of the tube while providing a sufficiently thick interface for the weld.

According to another aspect of the disclosure, a driveline assembly is provided for a vehicle. The driveline assembly includes a tube of an aluminum material that extends about and along an axis between a proximal end and a distal end. The tube has an outer surface and an inner surface. A fitting of a steel material extends axially between a first end and a second end. The first end is coupled with the distal end of the tube with a weld. The tube has a thicker portion at the distal end with a first thickness between the outer surface and the inner surface. The tube also has a thinner portion axially adjacent to the thicker portion with a second thickness between the outer surface and the inner surface. The first thickness is greater than the second thickness to reduce weight of the tube and provide a sufficiently thick interface for the weld.

According to another aspect of the disclosure, a propeller shaft assembly for a vehicle is provided. The propeller shaft assembly includes a tube of an aluminum material extending about and along an axis between a proximal end and a distal end and having an outer surface and an inner surface. A spline shaft of a steel material extends axially between a first end and a second end, wherein the first end is coupled with the distal end of the tube and the second end and presents a plurality of splines for coupling with a universal joint. A weld interconnects the first end of the spline shaft and the distal end of the tube. The tube has a thicker portion at the distal end with a first thickness between the outer surface and the inner surface, and a thinner portion axially adjacent to the thicker portion with a second thickness between the outer surface and the inner surface. The first thickness is greater than the second thickness to reduce weight of the tube and provide a sufficiently thick interface for the weld.

The disclosure therefore provides a lightweight driveline assembly that has a bi-metallic weld between a tube and fitting with a long cyclic torsional fatigue life or higher torsional strength. More particularly, the thicker portion of the tube provides a large surface area for the weld, thus providing a long cyclic torsional fatigue life or higher torsional strength, while the thinner portion reduces the weight of the driveline assembly.

Further areas of applicability will become apparent from the detailed description provided herein. As noted, the description provided in this summary section are intended for purposes of illustration only and is not intended to limit the scope of the present disclosure.

### DRAWINGS

The foregoing and other aspects will now be described by way of non-limiting examples with reference to the attached drawings in which:

FIG. 1 is a side cross-sectional, cutaway view of an example embodiment of a driveline assembly according to an aspect of the disclosure; and

FIG. 1A is a side, cross-sectional, cutaway view of an interface of a tube and fitting of the driveline assembly of FIG. 1, wherein a weld is positioned at the interface of the tube and the fitting.

### DETAILED DESCRIPTION

Example embodiments will now be described more fully with reference to the accompanying drawings.

A propeller shaft assembly 20 for a driveline assembly of a vehicle is generally shown. As is known by one of ordinary skill in the art, a driveline assembly of a vehicle typically includes the components of a powertrain of the vehicle aside from the engine. Such components may include a flywheel, transmission, propeller shaft, rear axle, final drive, differential, etc. It should be appreciated that the subject propeller shaft assembly 20 could be used on various vehicles including, but not limited to automobiles, recreational vehicles and all-terrain vehicles.

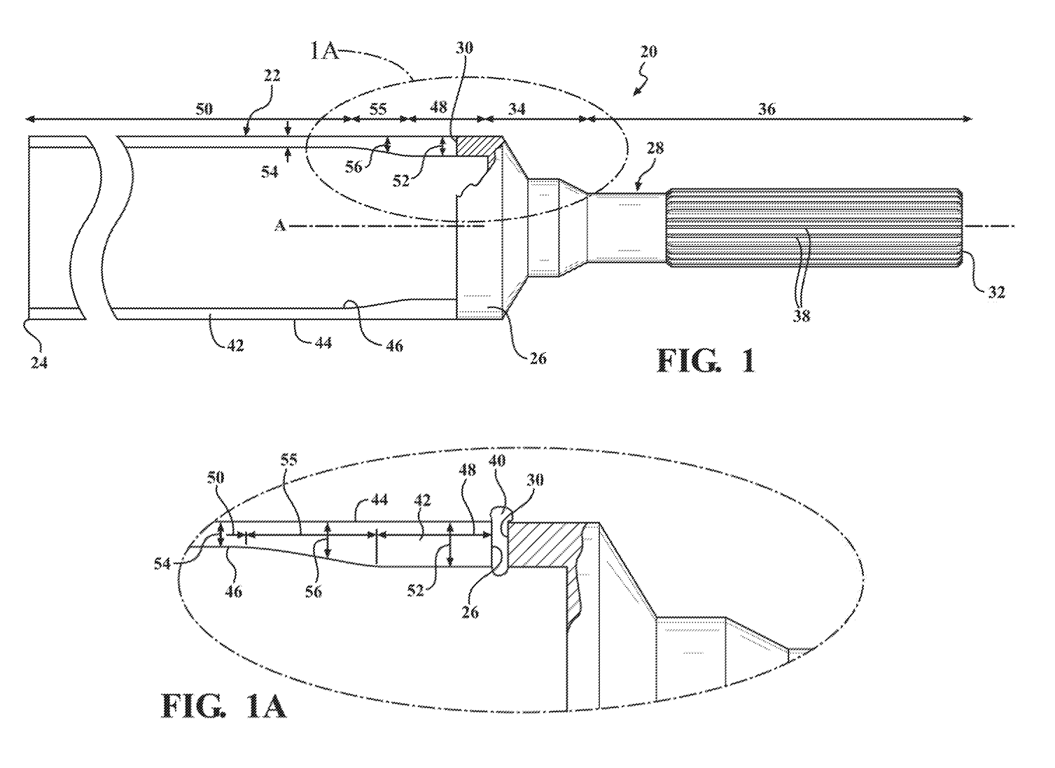

As best illustrated in FIG. 1, the subject propeller shaft assembly 20 includes a tube 22 of a first material such as aluminum that extends about and along an axis A between a proximal end 24 and a distal end 26. A fitting 28 of a second material such as steel is disposed along the axis A and coupled with the distal end 26 of the tube 22. The fitting 28 extends axially between a first end 30 and a second end 32. In the example embodiment, the fitting is a spline shaft 28, however, it should be appreciated that the fitting 28 could be other driveline components including, but not limited to a universal joint tube yoke, an internally splined slip yoke, an internally splined sleeve, a trilobe yoke for a flexible rubber coupling, a stub shaft of a constant velocity joint or an outer race of a constant velocity joint without departing from the scope of the subject disclosure. It should be appreciated that other materials could be chosen for the first and second materials, however, according to the example embodiment, aluminum is employed for the tube 22 for its light weight properties, while steel is employed for the fitting 28 because of its high-strength properties. Other low mass materials could be utilized for the tube 22 and other high mass materials could be utilized for the fitting 28.

The spline shaft 28 has a tapered region 34 at the first end 30 and a cylindrical region 36 that extends from the tapered region 34 to the second end 32. The tapered region 34 generally tapers radially inwardly between the first end 30 and the cylindrical region 36. A plurality of splines 38 are defined along the cylindrical region 36 adjacent to the second end 32 of the spline shaft 28 for being received by an internally splined component such as a slip yoke or sleeve to allow for an adjustment in the axial length of the propeller shaft assembly 20 or attachment of a constant velocity joint. As best shown in FIG. 1A, a weld 40 (schematically shown) is defined between the first end 30 of the spline shaft 28 and the distal end 26 of the tube 22 to interconnect the spline shaft 28 and tube 22. According to the example embodiment, the weld 40 is formed by a friction welding process, however, it should be appreciated that other welding processes could be utilized including, but not limited to, MIG welding, and magnetically-impelled arc butt (MIAB) welding. It should also be appreciated that the first end of another style fitting may be welded in the same manner.

With reference to both FIGS. 1 and 1A, the tube 22 has a wall 42 that has an outer surface 44 and an inner surface 46. The wall 42 has a thicker portion 48 adjacent to the distal end 26 of the tube 22, and a thinner portion 50 adjacent to the proximal end 24 of the tube 22. The thicker portion 48 has a first thickness 52 between the outer surface 44 and the inner surface 46. The thinner portion 50 has a second thickness 54 between the outer surface 44 and the inner surface 46. The first thickness 52 is greater than the second thickness 54 to provide for a sufficiently thick interface between the tube 22 and the spline shaft 28 such that the weld 40 has a long cyclic torsional fatigue life or higher torsional strength, while also providing for a light weight tube 22 due to the decreased material thickness along the thinner portion 50. A transition portion 55 is defined between the thicker portion 48 and the thinner portion 50. The transition portion 55 has a third thickness 56 that tapers at a continuous slope between the thicker portion 48 and the thinner portion 50. It should be appreciated that the transition portion 55 could have various shapes, e.g., an arc shape.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A driveline assembly for a vehicle, the driveline assembly including:
a tube of a first material extending about and along an axis between a proximal end and a distal end and having an outer surface and an inner surface;
a fitting of a second material extending axially between a first end and a second end, wherein the first end is coupled with the distal end of the tube;
a weld interconnecting the first end of the fitting and the distal end of the tube; and
the tube having a thicker portion at the distal end with a first thickness between the outer surface and the inner surface, and a thinner portion axially adjacent to the thicker portion with a second thickness between the outer surface and the inner surface, wherein the first thickness is greater than the second thickness to reduce weight of the tube and provide a sufficiently thick interface for the weld.

2. The driveline assembly for a vehicle as set forth in claim 1 wherein the fitting is a spline shaft including a plurality of splines adjacent to the second end of the spline shaft for coupling with a universal joint.

3. The driveline assembly for a vehicle as set forth in claim 1 wherein the fitting is one of a universal joint tube yoke, an internally splined slip yoke, an internally splined sleeve, a trilobe yoke for a flexible rubber couplings, a stub shaft of a constant velocity joint, and an outer race of a constant velocity joint.

4. The driveline assembly for a vehicle as set forth in claim 1 wherein the first material is aluminum and the second material is steel.

5. The driveline assembly for a vehicle as set forth in claim 1 wherein the tube has a transition portion axially between the thicker portion and the thinner portion, and wherein the transition portion has a third thickness that tapers radially inwardly between the thicker portion and the thinner portion.

6. A driveline assembly for a vehicle, the driveline assembly including:
a tube of an aluminum material extending about and along an axis between a proximal end and a distal end and having an outer surface and an inner surface;
a fitting of a steel material extending axially between a first end and a second end, wherein the first end is coupled with the distal end of the tube;
a weld interconnecting the first end of the fitting and the distal end of the tube; and
the tube having a thicker portion at the distal end with a first thickness between the outer surface and the inner surface, and a thinner portion axially adjacent to the thicker portion with a second thickness between the outer surface and the inner surface, wherein the first thickness is greater than the second thickness to reduce weight of the tube and provide a sufficiently thick interface for the weld.

7. The driveline assembly for a vehicle as set forth in claim 6 wherein the fitting is a spline shaft including a plurality of splines adjacent to the second end of the spline shaft for coupling with a universal joint.

8. The driveline assembly for a vehicle as set forth in claim 6 wherein the fitting is one of a universal joint tube yoke, an internally splined slip yoke, an internally splined sleeve, a trilobe yoke for a flexible rubber couplings, a stub shaft of a constant velocity joint, and an outer race of a constant velocity joint.

9. The driveline assembly for a vehicle as set forth in claim 6 wherein the tube has a transition portion axially between the thicker portion and the thinner portion, and wherein the transition portion has a third thickness that tapers radially inwardly between the thicker portion and the thinner portion.

10. A propeller shaft assembly for a vehicle, the propeller shaft assembly including:
a tube of an aluminum material extending about and along an axis between a proximal end and a distal end and having an outer surface and an inner surface;
a spline shaft of a steel material extending axially between a first end and a second end, wherein the first end is coupled with the distal end of the tube and the second end presents a plurality of splines for coupling with a universal joint;
a weld interconnecting the first end of the spline shaft and the distal end of the tube; and
the tube having a thicker portion at the distal end with a first thickness between the outer surface and the inner surface, and a thinner portion axially adjacent to the thicker portion with a second thickness between the outer surface and the inner surface, wherein the first thickness is greater than the second thickness to reduce weight of the tube and provide a sufficiently thick interface for the weld.

11. The driveline assembly for a vehicle as set forth in claim 10 wherein the fitting is a spline shaft including a plurality of splines adjacent to the second end of the spline shaft for coupling with a universal joint.

12. The driveline assembly for a vehicle as set forth in claim 11 wherein the fitting is one of a universal joint tube yoke, an internally splined slip yoke, an internally splined sleeve, a trilobe yoke for a flexible rubber couplings, a stub shaft of a constant velocity joint, and an outer race of a constant velocity joint.

13. The driveline assembly for a vehicle as set forth in claim 11 wherein the tube has a transition portion axially between the thicker portion and the thinner portion, and wherein the transition portion has a third thickness that tapers radially inwardly between the thicker portion and the thinner portion.
